(19) United States
(12) Patent Application Publication
(10) Pub. No.: US 2024/0059894 A1
(43) Pub. Date: Feb. 22, 2024

(54) POLYPHENYLENE SULFIDE RESIN COMPOSITION AND MOLDED ARTICLE FOR AUTOMOTIVE PARTS MANUFACTURED USING THE SAME

(71) Applicants: HYUNDAI MOBIS CO., LTD., Seoul (KR); LG CHEM, LTD, Seoul (KR)

(72) Inventors: Hyoung Taek KANG, Yongin-si (KR); Hyeon Don KIM, Yongin-si (KR); Eun Chang LEE, Yongin-si (KR); Hye Seung HAM, Yongin-si (KR); Jae Chan PARK, Yongin-si (KR); In Seok SEO, Yongin-si (KR); Hyun Tae KIM, Yongin-si (KR)

(73) Assignees: HYUNDAI MOBIS CO., LTD., Seoul (KR); LG CHEM, LTD., Seoul (KR)

(21) Appl. No.: 18/233,538

(22) Filed: Aug. 14, 2023

(30) Foreign Application Priority Data
Aug. 18, 2022 (KR) 10-2022-0103440

(51) Int. Cl. C08L 81/02; C08K 9/06; C08K 3/26

(52) U.S. Cl. CPC C08L 81/02; C08K 9/06; C08K 3/26; C08K 2003/265; C08K 2201/003; C08K 2201/004; C08K 2201/005

(57) ABSTRACT

Exemplary embodiments relate to a polyphenylene sulfide resin composition and a molded article for automotive parts, which is manufactured using the same and has excellent insulating properties and impact resistance, which can be applied to drive motor terminal assemblies and the like.

### CROSS-REFERENCE TO RELATED APPLICATION

This application claims priority to and the benefit of Korean Patent Application No. 10-2022-0103440, filed on Aug. 18, 2022, the disclosure of which is incorporated herein by reference in its entirety.

### BACKGROUND

### 1. Field of the Invention

The present invention relates to a polyphenylene sulfide resin composition and a molded article for automotive parts, which is manufactured using the same and has excellent insulating properties and impact resistance, which can be applied to drive motor terminal assemblies and the like.

### 2. Discussion of Related Art

A drive motor terminal assembly has a structure which is connected to transmit power supplied from a high voltage connector to the coils of the stator assembly, and the motor is driven using electrical energy supplied from the coils by the terminals. The FIGURE illustrates an exploded view of an automobile drive motor including a terminal assembly and a schematic view of the terminal assembly.

Since drive motor terminal assemblies in the related art have problems in that electrical insulation deteriorates after long-term heat resistance due to the characteristics of plastic materials, it is difficult to secure stable functions. Further, in order to prevent cracks due to thermal shock of overmolded parts, a large amount of impact reinforcing agent was added to prevent cracks.

However, since the impact reinforcing agent, which is formulated to prevent cracks due to thermal shock, deteriorates in a high temperature environment to cause problems such as reduced strength and electrical insulation, it is difficult to secure the quality stability of a drive motor. Meanwhile, when an impact reinforcing agent is not added to a resin composition for manufacturing a drive motor terminal assembly, insulation may be improved, but a problem in that thin surface cracks caused by thermal shock are induced cannot be solved.

Therefore, there is a need for developing a resin composition for automobiles, which can suppress a reduction in insulation due to deterioration of an impact reinforcing agent formulated to prevent cracks caused by thermal shock and simultaneously securing impact resistance.

### SUMMARY OF THE INVENTION

An object of the present invention is to provide a resin composition for manufacturing a molded article for automotive parts, which can secure both insulation and impact resistance.

Another object of the present invention is to provide a resin composition capable of reducing the occurrence of cracks in parts and improving the long-term durability of a drive motor, and a molded article for automotive parts manufactured using the same.

Still another object of the present invention is to provide a drive motor terminal assembly of an automobile, which secures both insulation and impact resistance, and improve the performance of the automobile accordingly.

According to an aspect of the present invention, provided is a polyphenylene sulfide resin composition for automotive parts, which includes 40 to 70 wt % of a polyphenylene sulfide resin, 20 to 40 wt % of glass fibers, 10 to 30 wt % of calcium carbonate, and 1 to 10 wt % of an impact modifier, wherein the impact modifier is one or more selected from an ethylene-acrylic ester-glycidyl methacrylate terpolymer, and a copolymer including a polyolefin elastomer and styrene-ethylene-butylene-styrene, and glycidyl methacrylate grafted to at least one of the polyolefin elastomer and the styrene-ethylene-butylene-styrene.

According to exemplary embodiments, the polyphenylene sulfide resin used in the resin composition preferably has a melt index in a range of 1700 to 1900 g/10 min, as measured at 315° C./5 Kg according to the ISO 1133 method.

According to exemplary embodiments, the glass fibers used in the resin composition may have an average diameter of 7 to 15 μm and a length of 2 to 5 mm, and are preferably surface-treated with a silane compound. In addition, the calcium carbonate used in the resin composition may have an average particle size in a range of 3 to 7 μm.

According to exemplary embodiments, the ethylene-acrylic ester-glycidyl methacrylate terpolymer used as the impact modifier may include methyl acrylate in a range of 20 to 28 wt % and glycidyl methacrylate in a range of 5 to 11 wt %. Other exemplary embodiments may further include one or more additives selected from the group consisting of a compatibilizer, a lubricant, a colorant, an antioxidant, a UV stabilizer, a flame retardant, a plasticizer, a heat stabilizer and an antistatic agent according to the use of a product to which the resin composition is applied.

Furthermore, provided is a molded article for automotive parts manufactured by melt-extrusion of the polyphenylene sulfide resin composition.

According to exemplary embodiments, the molded article for automotive parts may have a tensile strength in a range of 148 to 160 MPa and a weld strength in a range of 47 to 60 MPa, as measured according to the ISO 527 (5 mm/min) test method.

According to exemplary embodiments, the molded article for automotive parts may have a dielectric breakdown strength in a range of 16 to 20 kV/mm as measured according to the IEC60243-1 test method.

According to exemplary embodiments, the molded article for automotive parts may have a CTI of grade 3 to grade 4 as measured according to the IEC 60112 test method.

According to exemplary embodiments, the molded article for automotive parts may have an elongation in a range of 1.6 to 2% as measured according to the ISO 527 test method.

According to exemplary embodiments, the molded article for automotive parts may have an IZOD impact strength (notched) in a range of 7.5 to 9.5 KJ/m² as measured at 25° C. according to the ISO 180 test method.

According to exemplary embodiments, the molded article for automotive parts may have a high-speed peak force of 190 to 212 N and a breaking energy in a range of 1.4 to 3.0 J as measured according to ISO 6603.

According to exemplary embodiments, the automotive part may be a drive motor terminal assembly.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

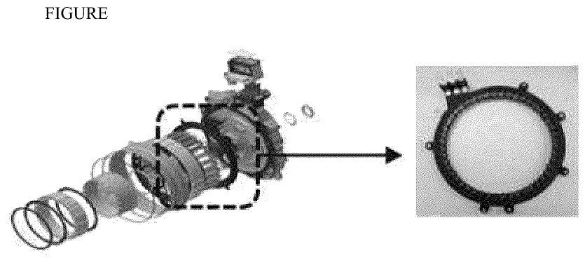

The FIG. 1s a schematic view of a drive motor terminal assembly of an automobile to which the resin composition according to an exemplary embodiment of the present invention is applied.

### DETAILED DESCRIPTION OF EXEMPLARY EMBODIMENTS

Hereinafter, the present invention will be described in more detail through examples and drawings. The following examples are presented by way of example to aid understanding of the present invention, and the scope of the present invention is not limited thereto. It is to be understood that the present invention can be modified and implemented in various forms, and includes all modifications, equivalents or alternatives falling within the spirit and scope of the present invention.

The terms used in the present application are used only to describe specific embodiments, and are not intended to limit the present invention. Singular expressions include plural expressions unless the context clearly indicates otherwise. In the present application, the term “include” or “have” is intended to indicate the presence of a characteristic, number, step, operation, constituent element, part or any combination thereof described in the specification, but it should be understood that the possibility of the presence or addition of one or more other characteristics or numbers, steps, operations, constituent elements, parts or any combination thereof is not precluded.

Unless defined otherwise, all terms used herein, including technical or scientific terms, have the same meaning as commonly understood by a person with ordinary skill in the art to which the present invention pertains. Terms such as those defined in commonly used dictionaries should be interpreted as having a meaning consistent with the meaning in the context of the relevant art and should not be interpreted as ideal or overly formal in meaning unless explicitly defined in the present application.

Specifically, the polyphenylene sulfide resin composition for automotive parts according to an aspect of the present invention includes 40 to 70 wt % of a polyphenylene sulfide resin, 20 to 40 wt % of glass fibers, 10 to 30 wt % of calcium carbonate, and 1 to 10 wt % of an impact modifier, wherein the impact modifier is one or more selected from an ethylene-acrylic ester-glycidyl methacrylate terpolymer, and a copolymer including a polyolefin elastomer and styrene-ethylene-butylene-styrene, and glycidyl methacrylate grafted to at least one of the polyolefin elastomer and the styrene-ethyl ene-butyl ene-styrene.

The polyphenylene sulfide resin has a melt index in a range of 1700 to 1900 g/10 min, as measured at 315° C./5 Kg according to the ISO 1133 method. In the present invention, since glass fibers and mineral fillers are excessively reinforced, when the melt index is out of the above range, overall moldability may deteriorate, and as a result, problems such as deterioration of physical properties and appearance defects may occur. Therefore, it is preferable to use a polyphenylene sulfide resin having a melt index in the above range.

In the polyphenylene sulfide resin composition, the glass fibers may be included in a range of 20 to 40 wt %, and the carbon carbonate may be included in a range of 10 to 30 wt %. When the glass fiber content is less than the above range, mechanical properties and flame retardancy may deteriorate, and when the content exceeds the above range, elongation and flowability may be reduced, so that the content is not preferred. In addition, when the content of the inorganic filler is less than the above range, the modulus may deteriorate, and when the content exceeds the above range, mechanical properties and flowability may be reduced, so that the content is not preferred.

Furthermore, the glass fibers used in the resin composition may have an average diameter of 7 to 15 μm and a length of 2 to 5 mm, and are preferably surface-treated with a silane compound. Further, the calcium carbonate used in the present invention may have an average particle size in a range of 3 to 7 μm.

As the silane compound used for the surface treatment of glass fibers, one or more selected from the group consisting of an amino silane-based compound, an epoxy silane-based compound, and a urethane-based silane compound may be selected, but the silane compound is not particularly limited thereto.

In addition, it is preferred that the ethylene-acrylic ester-glycidyl methacrylate terpolymer used as the impact modifier includes methyl acrylate in a range of 20 to 28 wt % and glycidyl methacrylate in a range of 5 to 11 wt %.

In addition to the above components, it is possible to further include one or more additives selected from the group consisting of a compatibilizer, a lubricant, a colorant, an antioxidant, a UV stabilizer, a flame retardant, a plasticizer, a heat stabilizer and an antistatic agent according to the use of a product to which the resin composition is applied.

Furthermore, as an aspect, the present provides a molded article for automotive parts, which can be applied to a terminal assembly of an automotive drive motor, and the like as a molded article manufactured by melt-extrusion of the polyphenylene sulfide resin composition.

The molded article for automotive parts has a tensile strength in a range of 148 to 160 MPa and a weld strength in a range of 47 to 60 MPa, as measured according to the ISO 527 (5 mm/min) test method. In the present invention, when the weld strength is less than 47 MPa, cracks caused by thermal shock are highly likely to occur, and when the weld strength is 60 MPa or more, a reduction in dimensional stability caused by a high content of impact modifier and a reduction in insulation and physical properties caused by heat resistant aging are likely to occur, which is not preferable.

The molded article for automotive parts has a dielectric breakdown strength in a range of 16 to 20 kV/mm as measured according to the IEC60243-1 test method, a CTI in a range of grade 3 to grade 4 as measured according to the IEC60112 test method, and an elongation in a range of 1.6 to 2% as measured according to the ISO 527 test method.

The molded article for automotive parts has an IZOD impact strength (notched) in a range of 7.5 to 9.5 KJ/m² as measured at 25° C. according to the ISO 180 test method, a high-speed peak force of 190 to 212 N and a breaking energy in a range of 1.4 to 3.0 J as measured according to the ISO 6603 test method. In the present invention, in the case of a material having a high-speed peak force of less than 190 N, cracks caused by thermal shock are highly likely to occur, and when the breaking energy is less than 1.4 J, the material becomes brittle, so that inferior properties against thermal shock may be exhibited. Therefore, the molded article according to the present invention has an advantage in that it is possible to implement both high peak force and high breaking energy.

### Example: Preparation of Polyphenylene Sulfide Resin Composition

A resin composition including a polyphenylene sulfide resin, glass fibers, an inorganic filler and an impact modifier was prepared according to the composition shown in the following Table 1, and melt-extruded to manufacture a molded article. After each component was mixed, a resin composition in the form of pellets was prepared by melting/kneading the resulting mixture at a temperature interval of 300 to 320° C. using a twin-screw extruder with L/D=42 and ¢=40 mm. Then, after the prepared resin composition in the form of pellets was dried at 120° C. for 2 hours or more, an ISO standard sample was injected at an injection temperature of 290 to 315° C. and a mold temperature of 140° C., and stored in a constant temperature and humidity chamber at 23° C. for 24 hours or more, and then physical properties were measured according to ISO standards.

Specific components used in the resin composition according to the present example are as follows.

(A) A polyphenylene sulfide (PPS) resin with a melt index of 1800 g/10 min at 315° C./5 Kg according to ISO 1133 was used.

(B) Glass fibers with a length of 3 mm and a diameter of 10 μm, which were surface-treated with an epoxy silane compound, were used.

(C) Calcium carbonate with an average particle size of 5 μm was used.

(D-1) A copolymer including a polyolefin elastomer and styrene-ethylene-butylene-styrene, and glycidyl methacrylate grafted to at least one of the polyolefin elastomer (POE) and the styrene-ethylene-butylene-styrene (SEBS) was used as an impact modifier.

(D-2) An ethylene-acrylic ester-glycidyl methacrylate terpolymer with 24% methyl acrylate and 8% glycidyl methacrylate was used as an impact modifier.

(D-3) A copolymer of ethylene and 1-butene was used as an impact modifier.

(D-4) Silicone-acrylic rubber was used as an impact modifier.

(E) A compatibilizer, a lubricant, and a colorant were used as other additives.

TABLE 1

| | | Example | Example | Example | Example |
|---|---|---|---|---|---|
| Constituent component | | 1 | 2 | 3 | 4 |
| PPS | A | 46 | 44 | 46 | 44 |
| Glass fiber | B | 30 | 30 | 30 | 30 |
| Inorganic filler | C | 20 | 20 | 20 | 20 |
| Impact modifier | D-1 | 3 | 5 | | |
| | D-2 | | | 3 | 5 |
| Additive | E | 1 | 1 | 1 | 1 |
| Dielectric | IEC60243-1 | 20 | 20 | 20 | 20 |
| breakdown | | | | | |
| voltage | | | | | |
| IZOD Imp | ISO 180 | 8.5 | 9.2 | 8.6 | 8.8 |
| strength | KJ/m² | | | | |

TABLE 2

| | | Comparative | Comparative | Comparative | Comparative | Comparative |
|---|---|---|---|---|---|---|
| Constituent component | | Example 1 | Example 2 | Example 3 | Example 4 | Example 5 |
| PPS | A | 69 | 49 | 29 | 44 | 44 |
| Glass fiber | B | 30 | 30 | 30 | 30 | 30 |
| Inorganic filler | C | | 20 | 40 | 20 | 20 |
| Impact modifier | D-3 | | | | 5 | |
| | D-4 | | | | | 5 |
| Additive | E | 1 | 1 | 1 | 1 | 1 |
| Dielectric | IEC60243-1 | 20 | 17 | 15 | 19 | 20 |
| breakdown voltage | | | | | | |
| IZOD Imp strength | ISO 180 KJ/m² | 8.8 | 7.5 | 5.7 | 8.3 | 7.7 |

Through the test results of the compositions according to Comparative Examples 1, 2 and 3, it can be seen that the impact strength and the dielectric breakdown voltage decrease when the content of the mineral filler is increased. Meanwhile, it can be seen that when (D-1) and (D-2) according to the present invention are used as impact modifiers, the dielectric breakdown voltage is maintained and the impact strength is increased despite an increase in the content of the inorganic filler.

In addition, through Comparative Examples 4 and 5, it can be seen that the use of (D-1) and (D-2) impact modifiers is effective for improving impact strength.

### Test Example 1: Evaluation of Physical Properties of Polyphenylene Sulfide Resin Composition

The results of measuring the physical properties of the polyphenylene sulfide resin composition prepared in Example 4 are shown in the following [Table 3].

TABLE 3

| Test items | Units | Test conditions | Example 4 |
|---|---|---|---|
| Tensile strength | MPa | ISO 527 | 160 |
| Elongation | % | (5 mm/min) | 1.7 |
| Flexural strength | MPa | ISO178 | 220 |
| Flexural modulus | | | 12,600 |
| IZOD impact (room | kJ/m² | Notched | 7.9 |
| temperature) | | | |
| IZOD impact (−40° C.) | | | 8.0 |
| High-speed peak force (1T) | N | Peak force | 212 |
| | J | Total E | 1.4 |

### Test Example 2: Evaluation of Moldability of Polyphenylene Sulfide Resin Composition

(1) Verification of Flowability

In addition, the flowability of the resin composition prepared according to Example 4 was verified using a Spiral 1.5T mold at mold temperature room temperature (50° C.), and as a result of measuring a spiral distance, the spiral distance was 210 mm at the beginning and 220 mm at the end (after 10 shots), which was evaluated as excellent flowability.

(2) Melt Viscosity

The melt viscosity of the resin composition prepared according to Example 4 was measured. As a test to evaluate the occurrence of burrs, which is a disadvantage of polyphenylene sulfide materials, a melt viscosity at 320° C. and a shear rate of 100 to about 3000 was measured, and the results are shown in the following [Table 4].

TABLE 4

| Classification | | Example 4 | Remarks |
|---|---|---|---|
| Shear rate (1/s) | 100 | 247 | Burr occurrence region |
| | 500 | 150 | |
| | 3000 | 84 | Injection region |

As a result of measuring the melt viscosity, it was evaluated that burrs were less likely to occur in the resin composition according to the present example.

### Test Example 3: Evaluation of Environmental Reliability of Molded Article

The molded article of the resin composition according to Example 4 was evaluated for environmental reliability under E36500-T-26 conditions, and the results are shown in the following [Table 5]. According to these results, it could be confirmed that the molded article according to the present example had excellent insulating properties.

TABLE 5

| | | | | | Dielectric |
|---|---|---|---|---|---|
| | | | | | break- |
| | | | | | down |
| | | Tensile | Weld | | strength |
| Item | Conditions | strength | strength | CTI | (kV/mm) |
| Allowed to | 135° C., 168 hr | 151 | 56 | Grade 4 | 18.1 |
| stand at high | | | | (150 V) | |
| temperature | | | | | |
| Allowed to | ATF 150° C., | 143 | 59 | Grade 3 | 16.5 |
| stand at | 300 hr | | | (180 V) | |
| intrinsic | | | | | |
| temperature | | | | | |
| Thermal | −40° C. ↔ 120° C., | 151 | 61 | Grade 4 | 18.5 |
| shock | 500 cycles | | | (150 V) | |

Furthermore, as a result of measuring the harsh environment reliability verification of the molded article using the resin composition of Example 4 according to the ISO 6603 test method, the surface impact resistance was also evaluated to be excellent.

TABLE 6

| | | Surface impact (Peak Force, N) | |
|---|---|---|---|
| Item | Harsh conditions | Initial | After harsh conditions |
| Allowed to | After being allowed to | 212 | 207 |
| stand at | stand at ATF 150° C. | | |
| intrinsic | for 1,000 hr | | |
| temperature | | | |
| Thermal shock | −40° C. ↔ 150° C., | 212 | 196 |
| | 500 cycles | | |

A molded article for automotive parts manufactured using the polyphenylene sulfide resin composition according to the present invention has an effect of improving part cracks caused by thermal shock, and can suppress a reduction in insulation caused by deterioration.

Further, it is possible to provide a terminal assembly for an automotive drive motor, which secures both insulation and impact resistance, thereby improving the durability of the drive motor to contribute to the development of high-performance automobiles.

Meanwhile, the effects of the present invention are not limited to those mentioned above, and other effects, which have not been mentioned, will be able to be clearly understood by those skilled in the art from the following description.

What is claimed is:

1. A polyphenylene sulfide resin composition comprising:
40 to 70 wt % of a polyphenylene sulfide resin,
20 to 40 wt % of glass fibers,
10 to 30 wt % of calcium carbonate, and
1 to 10 wt % of an impact modifier,
wherein the impact modifier is one or more selected from an ethylene-acrylic ester-glycidyl methacrylate terpolymer, and a copolymer including a polyolefin elastomer and styrene-ethylene-butylene-styrene, and glycidyl methacrylate grafted to at least one of the polyolefin elastomer and the styrene-ethylene-butylene-styrene.

2. The polyphenylene sulfide resin composition of claim 1, wherein the polyphenylene sulfide resin has a melt index in a range of 1700 to 1900 g/10 min, as measured at 315° C./5 Kg according to the ISO 1133 method.

3. The polyphenylene sulfide resin composition of claim 1, wherein the glass fibers have an average diameter of 7 to 15 μm and a length of 2 to 5 mm.

4. The polyphenylene sulfide resin composition of claim 1, wherein the glass fibers are surface-treated with a silane compound.

5. The polyphenylene sulfide resin composition of claim 1, wherein the calcium carbonate has an average particle size of 3 to 7 μm.

6. The polyphenylene sulfide resin composition of claim 1, wherein the ethylene-acrylic ester-glycidyl methacrylate terpolymer comprises methyl acrylate in a range of 20 to 28 wt % and glycidyl methacrylate in a range of 5 to 11 wt %.

7. The polyphenylene sulfide resin composition of claim 1, further comprising one or more selected from the group consisting of a compatibilizer, a lubricant, a colorant, an antioxidant, a UV stabilizer, a flame retardant, a plasticizer, a heat stabilizer, and an antistatic agent.

8. A molded article for automotive parts manufactured by melt-extrusion of the polyphenylene sulfide resin composition of claim 1.

9. The molded article of claim 8, wherein the molded article has a tensile strength in a range of 148 to 160 MPa and a weld strength in a range of 47 to 60 MPa, as measured according to the ISO 527 (5 mm/min) test method.

10. The molded article of claim 8, wherein the molded article has a dielectric breakdown strength in a range of 16 to 20 kV/mm as measured according to the IEC60243-1 test method.

11. The molded article of claim 8, wherein the molded article has a CTI of grade 3 to grade 4 as measured according to the IEC 60112 test method.

12. The molded article of claim 8, wherein the molded article has an elongation of 1.6 to 2% as measured according to the ISO 527 test method.

13. The molded article of claim 8, wherein the molded article has an IZOD impact strength (notched) in a range of 7.5 to 9.5 KJ/m² as measured at 25° C. according to the ISO 180 test method.

14. The molded article of claim 8, wherein the molded article has a high-speed peak force of 190 to 212 N and a breaking energy in a range of 1.4 to 3.0 J as measured according to ISO 6603.

15. The molded article of claim 8, wherein the molded article is a drive motor terminal assembly.
